(19) United States
(12) Patent Application Publication
(10) Pub. No.: US 2006/0124824 A1
(43) Pub. Date: Jun. 15, 2006

(54) Motorcycle wheel maintenance support

(76) Inventor: Michael Lawrence Taylor, Thundersley (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/542,900

(22) PCT Filed: Jan. 20, 2004
(86) PCT No.: PCT/GB04/00209

§ 371 Date: Jul. 20, 2005

(30) Foreign Application Priority Data
Jan. 23, 2003 (GB) 0301502.1

(51) Int. Cl. F16M 5/00

(52) U.S. Cl. 248/671

(57) ABSTRACT

A maintenance support (10) for a motorcycle wheel (30) has a base frame (11) with a working area (14) defined between a pair of opposed side walls (12) and a pair of spaced parallel axles (15) extending transversely from one side wall (12) to the other. Each axle (15) is provided with a pair of spaced rollers (16) adapted to support a motorcycle wheel (30) thereon. Each roller (16) is mounted on its respective axle (15) for free rotation, independently of the other roller (16) of the pair, and each pair of rollers (16) co-operates to present a generally V-shaped profile to a motorcycle wheel (30) located on the maintenance support (10).

This invention relates to a support for a motorcycle wheel, to enable maintenance, such as cleaning or repairs, to be carried out. In particular, it relates to such a support, which allows the motorcycle wheel to be rotated freely on the support during maintenance.

Motorcycles are typically fitted with a side stand, designed to steady the motorcycle when not in use. The motorcycle is generally parked with both wheels in contact with the ground, and at an angle slightly reclined from the vertical. The side stand acts to retain the motorcycle in this reclined angle, thus preventing it from falling over, however the majority of the motorcycle's weight is still borne by the wheels. This makes rotation of the wheels extremely difficult—or in the case of larger and heavier motorcycles, essentially impossible.

Rotation of a parked motorcycle's wheels is however essential when carrying out routine maintenance of the wheels and other associated working parts. For example, such routine maintenance might include inspection, cleaning and repair of the wheels and tyres, and lubrication of the drive chain system.

Previous attempts at addressing this problem have involved jacking a wheel of the motorcycle off the ground to enable it to rotate freely. However, in view of the substantial weight of some motorcycles, this method is potentially dangerous, as well as being labour-intensive and time-consuming.

An alternative is to provide a support comprising two or more rollers, on which a wheel of the motorcycle is located. The other wheel remains in contact with the ground, and the side stand is used to prevent the motorcycle falling over. The wheel located on the support can thus be freely rotated on the rollers to enable maintenance to be carried out.

Although in principle this manner of enabling free rotation of a wheel of a parked motorcycle is satisfactory, existing supports provided for this purpose have proved inadequate. The problems encountered by users of such known supports tend to stem from the use therein of straight, cylindrical rollers provided on fixed axles. Since the motorcycle wheel is usually inclined at an angle relative to the rollers, rotation of the wheel causes it to move along the roller, thus making the whole system unstable and therefore unsafe. This problem is referred to herein as “wheel creep”. Additionally, such known supports tend to be manufactured for use only with one particular standard size and configuration of motorcycle wheel, and thus cannot accommodate motorcycle wheels of differing size and configuration.

The present invention seeks to address the above-identified problems by providing an improved motorcycle wheel maintenance support, on which substantially all sizes and configurations of motorcycle wheel may be rotated without wheel creep occurring.

According to the present invention there is provided a maintenance support for a motorcycle wheel, said support comprising:

a base frame having a working area defined between a pair of opposed side walls and a pair of spaced parallel axles extending transversely from one side wall to the other, each said axle being provided with a pair of spaced rollers adapted to support a motorcycle wheel thereon;

and wherein each member of each said pair of spaced rollers is freely rotatable about its respective axle independently of the other member of said pair, and each pair of rollers co-operates to present a generally V-shaped profile to a motorcycle wheel to be located on said maintenance support.

The term “generally V-shaped” is used herein in its broadest sense, and thus describes the subtending between the paired rollers of any angle less than 180°. In practice, the angle subtended between the paired rollers will preferably be in the range of from 115° to 155°, and most preferably will be substantially 135°.

The presentation of a generally V-shaped profile to the motorcycle wheel is essential to the prevention of wheel creep, and may be achieved in one of two ways, giving rise to alternate embodiments of the present invention.

In a first embodiment of the present invention, each axle is generally clindrical and each roller is generally conical or frusto-conical. The generally V-shaped profile is thus obtained by the opposed surfaces of the conical rollers, which will be mounted on the axle with their smaller ends oriented towards the centre of the support. In this embodiment, each axle may be freely rotatable relative to the base frame.

In a second embodiment of the present invention, each axle comprises a central generally V-shaped portion, whilst each roller is generally cylindrical. The generally V-shaped profile is thus obtained by the opposed surfaces of the cylindrical rollers, which will be mounted on either side of the generally V-shaped central portion of the axle. Clearly, in this embodiment each axle must be held stationary relative to the base frame. For this purpose, the base frame may further comprise a central rib adapted to support said central V-shaped portion of each axle.

Whether the maintenance support of the present invention is provided in its first or second embodiments, it is essential that each paired roller is freely rotatable independently of the other member of the pair. As a motorcycle wheel located on the support will often be inclined, the rotation of the wheel will cause different rotational forces to be applied at different points of contact—i.e. different forces will be applied to each paired roller. Since the rollers are free to rotate independently, this will cause the rollers forming either side of the “V” to rotate at different speeds. This is important so as to prevent, or at least significantly reduce, the “build-up” of friction between the motorcycle wheel and the rollers.

In order to facilitate the independent rotation of the paired rollers, a bearing is preferably located centrally on each axle, said bearing also maintaining the separation between each pair of spaced rollers.

The base frame may further comprises a pair of opposed end walls, each of which will preferably be inclined to form a ramp suitable for permitting a motorcycle wheel to enter and exit the working area. Most preferably, each said ramp is formed with a generally V-shaped cut-out portion adjacent its upper edge, said cut-out portion being aligned with the generally V-shaped profile of the rollers. A motorcycle can thus easily be ridden or rolled onto and off the support.

The mounting of each axle on the side walls may conveniently be achieved by the ends of said axles extending through mounting holes or slots provided in the side walls. A bearing is preferably provided at each end of each axle, to enable the rotational mounting of said axles in said mounting holes or slots. Most preferably, each said bearing is provided with a flange, to assist in retaining the rollers centrally on their respective axle.

In order that the maintenance support of the present invention should fulfil its stated object of accommodating substantially all sizes of motorcycle wheel, it is desirable that the size of the working area should be adjustable. This may be achieved by providing the side walls with a series of mounting holes or slots spaced along the length thereof, with the axles being adapted for removable mounting in said holes or slots. The removable mounting may preferably be achieved by the use of a clip associated with each end of each axle.

Where the side walls are provided with slots rather than holes, the maintenance support may further comprise retainer plates to retain the axles in said slots.

The base frame may be open along its underside, or alternatively may further comprise a generally rectangular base member extending beneath said working area. Such a base member may be required where it is desired to protect the floor or ground beneath the working area from oils and lubricants etc.

To prevent the base frame slipping on the floor or ground during rotation of the motorcycle wheel, the base frame preferably further comprises a plurality of feet provided on the underside thereof. Most preferably, the underside of the base frame and/or the feet is/are formed from, or provided with, an anti-slip material, such as rubber.

In order that the present invention may be fully understood, preferred embodiments thereof will now be described in detail, though only by way of example, with reference to the accompanying drawings, in which:

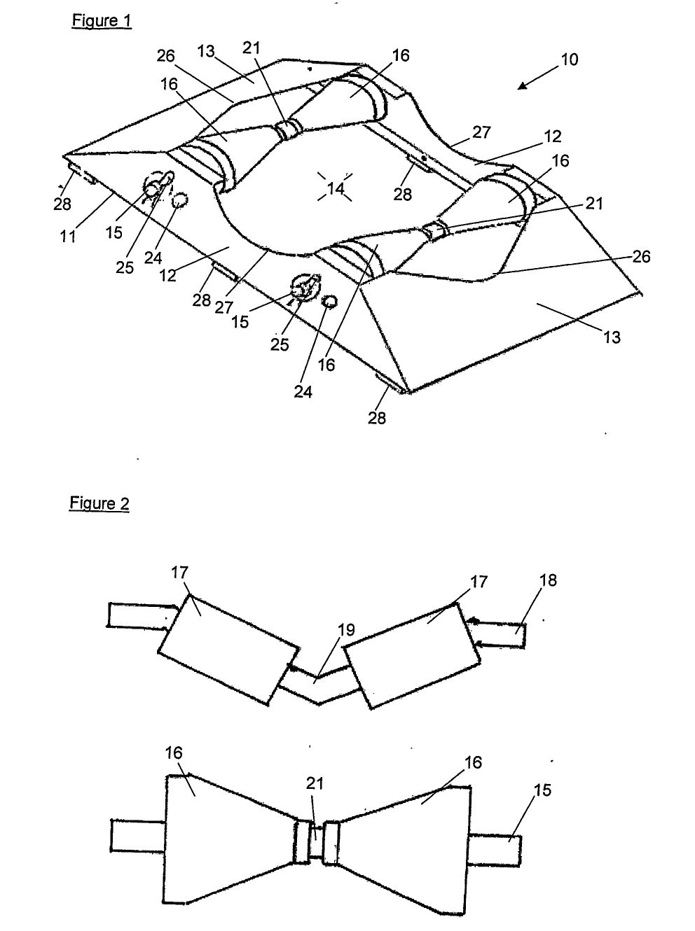

FIG. 1 shows a perspective view of a first embodiment of motorcycle wheel maintenance support according to the present invention;

FIG. 2 shows alternate constructions of roller and axle assemblies for use in different embodiments of maintenance support according to the present invention;

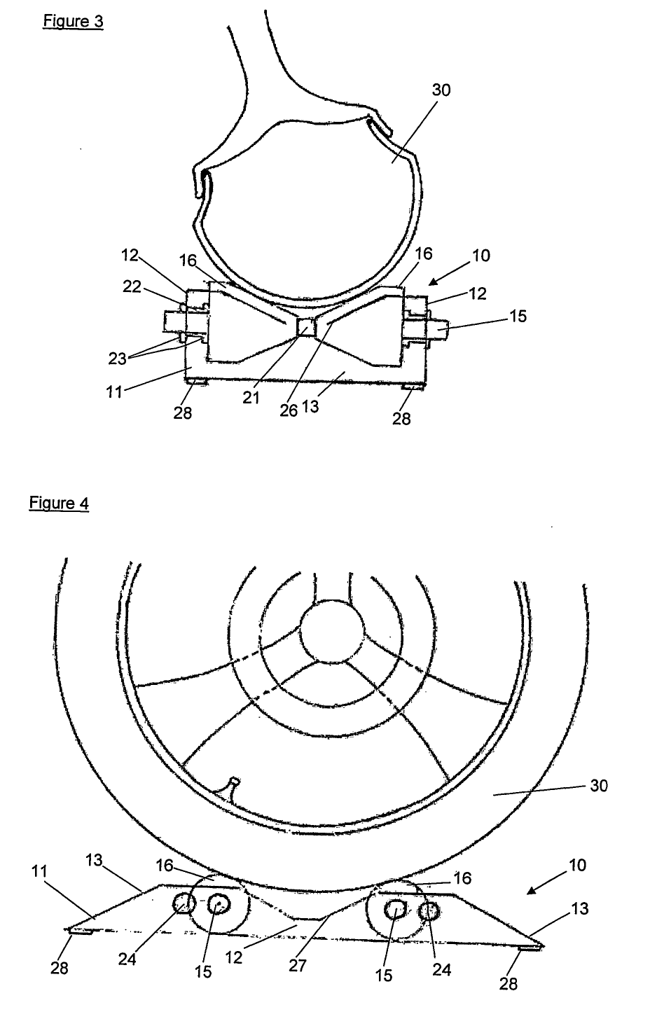

FIG. 3 shows a cross-sectional end view of the maintenance support of FIG. 1, having a motorcycle wheel located thereon;

FIG. 4 shows a cross-sectional side view of the maintenance support and motorcycle wheel of FIG. 3;

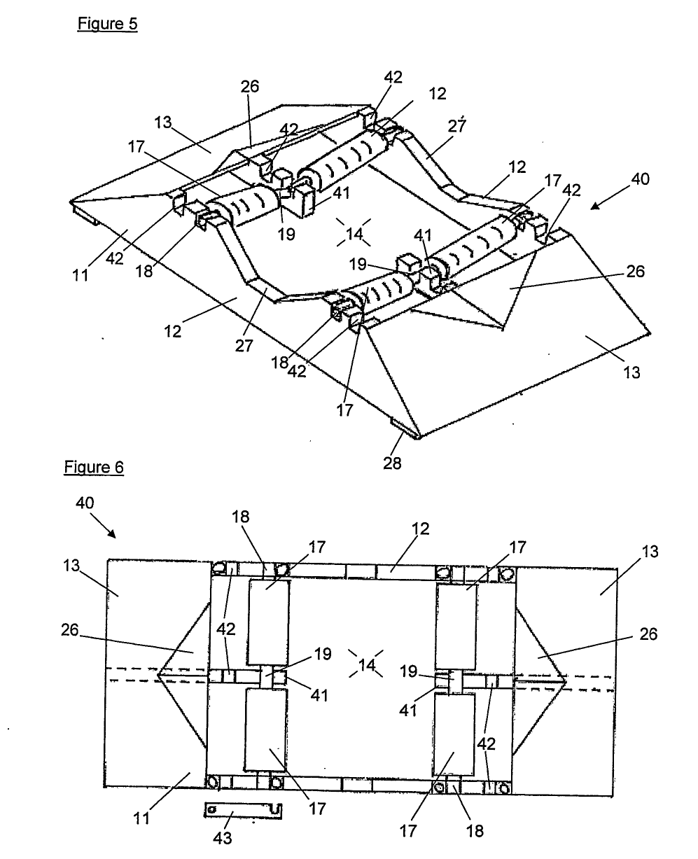

FIG. 5 shows a perspective view of a second embodiment of maintenance support according to the present invention;

FIG. 6 shows a plane view of the maintenance support of FIG. 5;

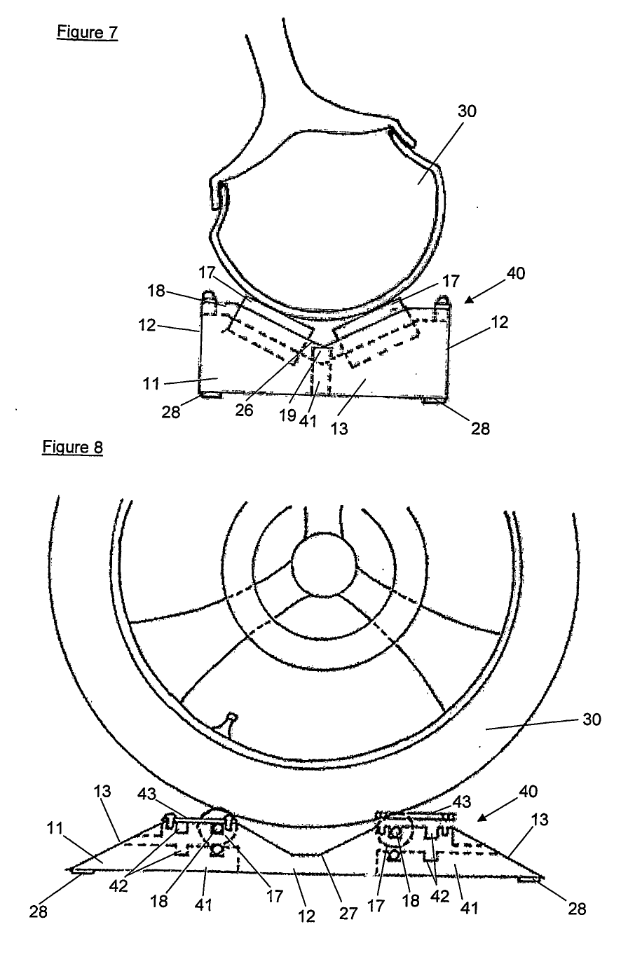

FIG. 7 shows a cross-sectional end view of the maintenance support of FIGS. 5 and 6, having a motorcycle wheel located thereon; and

FIG. 8 shows a cross-sectional side view of the maintenance support and motorcycle wheel of FIG. 7.

Referring first to FIG. 1, there is shown a first embodiment of motorcycle wheel maintenance support, generally indicated 10, according to the present invention. The support 10 comprises a base frame 11, having a pair of opposed side walls 12, and a pair of opposed end walls 13, inclined to form ramps so as to permit access to and egress from a working area 14, defined within the walls 12, 13.

A pair of straight parallel axles 15 extend across the working area 14 from one side wall 12 to the other. Each axle 15 carries a pair of conical rollers 16, each roller 16 being mounted for free rotational movement about its respective axle 15, independently of the other member of the pair. The conical rollers 16 are mounted on the axles 15 in an opposed arrangement so as to form a generally V-shaped cross-sectional profile, as is best seen from FIG. 2.

As is also shown in FIG. 2, the V-shaped cross-sectional profile of the roller-and-axle assembly may alternatively be achieved by the provision of a pair of straight rollers 17 mounted on an axle 18 having a central V-shaped portion 19 formed therein. A second embodiment of motorcycle wheel maintenance support incorporating such a straight roller 17 and V-shaped axle 18 assembly, will be discussed in more detail below with reference to FIGS. 5 to 8.

Referring now simultaneously to FIGS. 1, 3 and 4, it can be seen that the conical rollers 16 are spaced apart on their axles 15 by means of a central bearing 21 mounted thereon, which facilitates the independent rotation of said rollers 16. Similar terminal bearings 22 are provided at the ends of the axles 15, where they are mounted on the side walls 12, to enable the axles 15 to rotate freely relative to the base frame 11. The terminal bearings 22 are provided with flanges 23 to retain the conical rollers 16 in the correct position on their axles 15.

The axles 15 are removably mounted on the side walls 12 by locating the terminal bearings 22 in one of a series of mounting holes 24 provided in the side walls 12. The axle 15 is then retained in the selected mounting hole 24 by means of a clip 25. By moving the axles 15 between the different holes 24 the distance between the axles 15- and thus the size of the working area 14—may be varied to enable the maintenance support to be utilised with varying sizes of motorcycle wheel 30.

To facilitate access and egress of a wheel 30 to and from the working area 14, the ramps 13 are each formed with a V-shaped cut-out section 26 adjacent their upper edges. The side walls 12 may also be provided with cut-out sections 27 to facilitate maintenance of a wheel 30 when located on the support 10. To prevent the support 10 slipping during use, the base frame 11 is provided with rubber feet 28.

As is best shown in FIG. 3, during use a motorcycle wheel 30 located on the support 10 will be inclined at an angle relative to the support 10. Rotation of the wheel 30 will therefore cause different rotational forces to be applied to either side of the support 10. As the rollers 16 are free to rotate independently of one another, this causes the rollers 16 to rotate at different speeds, thus preventing, or at least significantly reducing, the build-up of friction between the wheel 30 and the rollers 16. The V-shaped profile presented by the rollers 16 ensures that the wheel 30 is retained centrally on the axle 15, and is prevented from “creeping” along the axle 15. The stability, and hence the safety, of the system is thus enhanced.

Referring now simultaneously to FIGS. 5 to 8, there is shown a second embodiment of motorcycle wheel maintenance support, generally indicated 40, according to the present invention. The second embodiment 40 is in many respects similar to the first embodiment 10 described above with reference to FIGS. 1, 3 and 4, and where applicable like reference numerals will be used to refer to like features.

The second embodiment 40 differs from the first embodiment in that the V-shaped cross-sectional profile of the roller-and-axle assembly is achieved by means of straight rollers 17 mounted on axles 18 having central V-shaped portions 19 formed therein, as described above with reference to FIG. 2. In this embodiment, the axles 18 must remain stationary relative to the base frame 11, and therefore the terminal bearings of the first embodiment are not required. To retain the axles 18 in a stationary position, the central V-shaped portions 19 thereof is secured to a central rib 41 formed integrally with the base frame 11. (Although not shown in FIGS. 1, 3 and 4, a similar central rib 41 may be incorporated into the first embodiment 10, adapted to support the central bearing 21).

The second embodiment 40 also differs from the first embodiment 10 in that the side walls 12, and the central rib 41, are provided with a series of mounting slots 42, rather than holes 24. In order the secure the axles 18 in the selected mounting slot 42, retainer plates 43 are provided, in place of the retaining clips 25.

1-19. (canceled)

20. A motorcycle wheel maintenance support, said support comprising:
a base frame having a pair of opposed side walls;
a working area defined within said base frame, between said side walls;
a pair of spaced parallel axles extending transversely across said working area from one said side wall to the other said side wall, each said axle being provided with a pair of spaced rollers adapted to support a motorcycle wheel thereon;
and wherein each member of each said pair of spaced rollers is freely rotatable about its respective axle independently of the other member of said pair, and wherein each pair of rollers co-operates to present a generally V-shaped profile to a motorcycle wheel to be located on said maintenance support.

21. The motorcycle wheel maintenance support of claim 20, wherein each axle is generally cylindrical and each roller is generally conical or frusto-conical.

22. The motorcycle wheel maintenance support of claim 21, wherein each axle is freely rotatable relative to the base frame.

23. The motorcycle wheel maintenance support of claim 20, wherein each axle is held stationary relative to the base frame and comprises a central generally V-shaped portion, and each roller is generally cylindrical.

24. The motorcycle wheel maintenance support of claim 23, wherein the base frame further comprises a central rib adapted to support said central V-shaped portion of each axle.

25. The motorcycle wheel maintenance support of claim 20, wherein a bearing is located centrally on each axle, said bearing maintaining the separation between each pair of spaced rollers.

26. The motorcycle wheel maintenance support of claim 20, wherein the base frame further comprises a pair of opposed end walls.

27. The motorcycle wheel maintenance support of claim 26, wherein each said end wall is inclined to form a ramp suitable for permitting a motorcycle wheel to enter and exit the working area.

28. The motorcycle wheel maintenance support of claim 27, wherein each said ramp is formed with a generally V-shaped cut-out portion adjacent its upper edge, said cut-out portion being aligned with the generally V-shaped profile of the rollers.

29. The motorcycle wheel maintenance support of claim 20, wherein each end of each axle extends through a mounting hole provided in the side walls.

30. The motorcycle wheel maintenance support of claim 29, wherein each end of each axle is provided with a bearing adapted to be mounted in a mounting hole.

31. The motorcycle wheel maintenance support of claim 30, wherein each said bearing is provided with a flange, to retain the rollers centrally on their respective axles.

32. The motorcycle wheel maintenance support of claim 29, wherein the side walls are provided with a series of mounting holes spaced along the length thereof, and the axles are adapted to be removably mounted in said holes, thus enabling the size of the working area to be varied.

33. The motorcycle wheel maintenance support of claim 32, wherein each end of each axle is provided with a clip to enable removable mounting of said axle in its respective mounting hole.

34. The motorcycle wheel maintenance support of claim 29, wherein the mounting holes take the form of slots, and further comprising retainer plates to retain the axles in said slots.

35. The motorcycle wheel maintenance support of claim 20, wherein the base frame further comprises a generally rectangular base member extending beneath said working area.

36. The motorcycle wheel maintenance support of claim 20, further comprising a plurality of feet provided on the underside of the base frame.

37. The motorcycle wheel maintenance support of claim 20, wherein the underside of the base frame is provided with an anti-slip material.
